(19) United States
(12) Patent Application Publication
(10) Pub. No.: US 2026/0010577 A1
(43) Pub. Date: Jan. 8, 2026

(54) PAGE PROCESSING

(71) Applicant: TENCENT TECHNOLOGY (SHENZHEN) COMPANY LIMITED, Shenzhen (CN)

(72) Inventors: Guangdong SUN, Shenzhen (CN); Weiwei HUANG, Shenzhen (CN); Sicheng HUANG, Shenzhen (CN); Shucheng ZHENG, Shenzhen (CN); Tingrong ZHONG, Shenzhen (CN); Ningyuan HUANG, Shenzhen (CN); Shun LI, Shenzhen (CN); Bin ZHU, Shenzhen (CN); Mingyang ZENG, Shenzhen (CN); Canhui HUANG, Shenzhen (CN); Kemian FENG, Shenzhen (CN); Fengmian GUO, Shenzhen (CN); Sixin GU, Shenzhen (CN); Wei ZHUO, Shenzhen (CN)

(73) Assignee: TENCENT TECHNOLOGY (SHENZHEN) COMPANY LIMITED, Shenzhen, GD (CN)

(21) Appl. No.: 19/327,704

(22) Filed: Sep. 12, 2025

Related U.S. Application Data
(63) Continuation of application No. PCT/CN2024/080894, filed on Mar. 11, 2024.

(30) Foreign Application Priority Data
Jul. 3, 2023 (CN) 202310806947.0

(51) Int. Cl. G06F 16/958; G06T 13/80

(52) U.S. Cl. CPC G06F 16/958; G06T 13/80

(57) ABSTRACT

Some aspects of the disclosure provide a page processing method. In some examples, an electronic device executes a host program that provides a host environment for a hosted program. Page navigation parameters of the hosted program are acquired, the page navigation parameters include address information of a first target page in the hosted program and custom routing information of the first target page. A rendering engine identifier for a rendering engine and a page identifier of the first target page are determined. A page tree is established in the hosted program according to the page identifier. The rendering engine is called to render the first target page based on the page tree and the page navigation parameters. Apparatus and non-transitory computer-readable storage medium counterpart embodiments are also contemplated.

### RELATED APPLICATIONS

The present application is a continuation of International Application No. PCT/CN2024/080894, filed on Mar. 11, 2024, which claims priority to Chinese Patent Application No. 202310806947.0, filed on Jul. 3, 2023. The entire disclosures of the prior applications are hereby incorporated by reference.

### FIELD OF THE TECHNOLOGY

This disclosure relates to the field of computer and communication technologies, including a program page processing technology.

### BACKGROUND OF THE DISCLOSURE

A hosted program is a program that relies on a host program and that can be used without the need of being downloaded and installed. For example, a mini program and a quick application are both hosted programs. A mini program is taken as an example, with continuous diversification of mini program applications, mini program developers are committed to providing users with smoother and better mini program applications.

Currently, Web View is a relatively commonly used mini-program interface rendering engine. Page routing (namely, a routing rule (a path) for navigating from a page to another page) can only adopt a default routing manner, that is, a page is pushed from a right end to a left end of an interface. Such a routing manner results in a single page presentation effect. It is not only difficult to meet requirements of developers for high customization and deep optimization, but also difficult to meet requirements of users for a natural and smooth experience in page switching.

### SUMMARY

Embodiments of this disclosure provide a page processing method and apparatus for a hosted program, a medium, and an electronic device, to meet requirements of developers for high customization and deep optimization, improve personalization, refinement, and flexibility of page routing, and meet requirements of users for a natural and smooth experience in page switching.

Some aspects of the disclosure provide a page processing method. In some examples, an electronic device executes a host program that provides a host environment for a hosted program. Page navigation parameters of the hosted program are acquired, the page navigation parameters include address information of a first target page in the hosted program and custom routing information of the first target page. A rendering engine identifier for a rendering engine and a page identifier of the first target page are determined. A page tree is established in the hosted program according to the page identifier. The rendering engine is called to render the first target page based on the page tree and the page navigation parameters.

Some aspects of the disclosure provide an information processing apparatus that includes processing circuitry configured to perform the page processing method.

Some aspects of the disclosure also provide a non-transitory computer-readable storage medium storing instructions which when executed by at least one processor cause the at least one processor to perform the page processing method.

In an aspect, the embodiments of this disclosure provide a page processing method for a hosted program. The hosted program runs within a host environment provided by a host program. The page processing method is performed by an electronic device running the host program, and includes: acquiring page navigation parameters of the hosted program, the page navigation parameters including address information of a first target page in the hosted program and custom routing information of the first target page; determining a rendering engine identifier and a page identifier that correspond to the first target page; and establishing a page tree corresponding to the hosted program according to the page identifier, and calling a rendering engine corresponding to the rendering engine identifier, to render the first target page based on the page tree and the page navigation parameters.

In an aspect, the embodiments of this disclosure provide a page processing apparatus for a hosted program. The hosted program runs within a host environment provided by a host program, and the page processing apparatus includes: an acquisition unit, configured to acquire page navigation parameters of the hosted program, the page navigation parameters including address information of a first target page in the hosted program and custom routing information of the first target page; a determination unit, configured to determine a rendering engine identifier and a page identifier that correspond to the first target page; and a processing unit, configured to establish a page tree corresponding to the hosted program according to the page identifier, and call a rendering engine corresponding to the rendering engine identifier, to render the first target page based on the page tree and the page navigation parameters.

In an aspect, the embodiments of this disclosure provide a computer-readable medium, which has a computer program stored therein. A processor (an example of processing circuitry) executes the computer program, to implement the page processing method for a hosted program according to the foregoing embodiments.

In an aspect, the embodiments of this disclosure provide an electronic device, which includes: one or more processors; and a memory configured to store one or more computer programs, the one or more processors executing the one or more programs, to cause the electronic device to implement the page processing method for a hosted program according to the foregoing embodiments.

In an aspect, the embodiments of this disclosure provide a computer program product, which includes a computer program. The computer program is stored in a computer-readable storage medium (e.g., non-transitory computer-readable storage medium). A processor of an electronic device reads the computer program from the computer-readable storage medium and executes the computer program, to cause the electronic device to perform the page processing method for a hosted program according to the foregoing embodiments.

According to the technical solutions provided in some embodiments of this disclosure, page navigation parameters of a hosted program are acquired. The page navigation parameters include address information of a first target page in the hosted program and custom routing information of the first target page. When the first target page to be displayed upon navigation is rendered by a first rendering engine supporting custom routing, a rendering engine identifier and a page identifier that correspond to the first target page are determined. Then, a page tree corresponding to the hosted program is established according to the page identifier, and a rendering engine corresponding to the rendering engine identifier is called, to render the first target page based on the page tree and the page navigation parameters. In this way, a developer is allowed to set the custom routing information of the specific page in the page navigation parameters of the hosted program, and then a custom routing manner of the page is rendered by the first rendering engine based on the custom routing information, whereby requirements of developers for high customization and deep optimization may be met, personalization, refinement, and flexibility of page routing are improved, and requirements of users for a natural and smooth experience in page switching are also met.

### BRIEF DESCRIPTION OF THE DRAWINGS

FIG. 1 is a schematic diagram of a system architecture to which technical solutions in embodiments of this disclosure may be applied.

FIG. 2 is a flowchart of a page processing method for a hosted program according to an embodiment of this disclosure.

FIG. 3 is a flowchart of a page processing method for a hosted program according to an embodiment of this disclosure.

FIG. 4 is a schematic diagram of a page routing manner rendered by a Web View engine.

FIG. 5 is a schematic diagram of a page routing manner implemented through technical solution in embodiments of this disclosure.

FIG. 6 is a schematic diagram of declaration of a builder function according to an embodiment of the present disclosure.

FIG. 7 is a schematic diagram of a mapping relationship between windowID and pageID according to an embodiment of this disclosure.

FIG. 8 is a processing flowchart of a page navigation process according to an embodiment of this disclosure.

FIG. 9 is a schematic diagram of implementation of hybrid routing isolation according to an embodiment of the present disclosure.

FIG. 10 is a block diagram of a page processing apparatus for a hosted program according to an embodiment of this disclosure.

FIG. 11 is a schematic structural diagram of a computer system adapted to implement an electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

In addition, the features, structures, or characteristics described in this disclosure may be combined in one or more embodiments in any appropriate manner. The following description has many specific details, whereby the embodiments of this disclosure can be understood. However, it is that, technical solutions of this disclosure may be implemented without using all detailed features in the embodiments, one or more particular details may be omitted, or other methods, elements, apparatuses, or operations may be used.

The block diagrams shown in the accompanying drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely example descriptions, do not need to include all content and operations/processes, and do not need to be performed in the described orders either. For example, some operations/processes may be further divided, while some operations/processes may be combined or partially combined. Therefore, an actual execution order may change according to an actual case.

In addition, “plurality” mentioned herein means two or more. The term “and/or” is used for describing an association relationship between associated objects and representing that three relationships may exist. For example, A and/or B may represent the following three cases: only A exists, both A and B exist, and only B exists. The symbol “/” generally indicates an “or” relationship between the associated objects.

The technical solution in the embodiments of this disclosure involve a hosted program and a host program. The hosted program is a program that relies on the host program and that can be used without the need of being downloaded and installed. For example, a mini program and a quick application are both hosted programs. A mini program is taken as an example. Currently, Web View is taken as a mini-program interface rendering engine. During page navigation, a new page can only be displayed in a manner of being pushed from a right end to a left end of an interface. Such a page routing manner results in a single page presentation effect. It is not only difficult to meet requirements of developers for high customization and deep optimization, but also difficult to meet requirements of users for a natural and smooth experience in page switching.

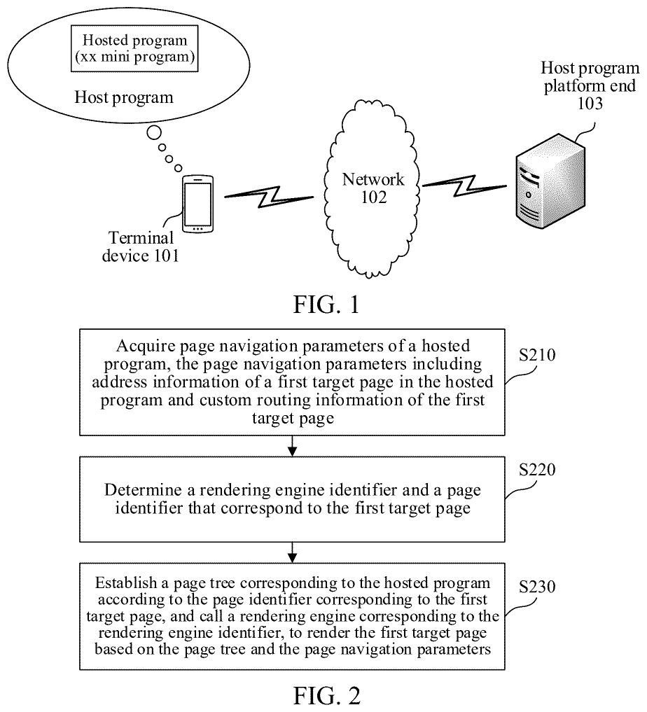

Based on the foregoing problem, the embodiments of this disclosure provide a solution of performing custom routing in a hosted program. In some aspects, as shown in FIG. 1, an example system architecture of this disclosure may include a terminal device 101, a network 102, and a host program platform end 103. The network 102 is a medium providing a communication link between the terminal device 101 and the host program platform end 103. The network 102 may include various connection types, such as a wired communication link and a wireless communication link.

In an embodiment of this disclosure, a host program runs on the terminal device 101. The host program may be an application program client, and the host program may communicate with the host program platform end 103 over the network 102, to display a host program page and complete a corresponding service function (such as message transmission and voice call). The host program provides a host environment, and the hosted program may run within the host environment provided by the host program. A developer may set, for the hosted program, page navigation parameters configured for performing custom routing, and then the host program may acquire the page navigation parameters of the hosted program. The page navigation parameters may include address information of a first target page in the hosted program and custom routing information of the first target page. If the first target page is rendered by a first rendering engine supporting custom routing, a rendering engine identifier and a page identifier that correspond to the first target page may be determined, then a page tree corresponding to the hosted program is established according to the page identifier, and a rendering engine corresponding to the rendering engine identifier is called, to render the first target page based on the page tree and the page navigation parameters.

It can be noted that in the technical solutions in the embodiments of this disclosure, a developer is allowed to set the custom routing information of the specific page in the page navigation parameters of the hosted program, and then a custom routing manner of the page may be rendered by the first rendering engine based on the custom routing information, whereby requirements of developers for high customization and deep optimization may be met, personalization, refinement, and flexibility of page routing are improved, and requirements of users for a natural and smooth experience in page switching are also met.

In addition, the host program platform end 103 involved in the embodiments of this disclosure may be an independent physical server, or may be a server cluster or distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal device 101 may be, but is not limited to, a smartphone, a tablet computer, a notebook computer, a desktop computer, a smart speaker, a smartwatch, an on-board terminal, a smart television, or the like.

Implementation details of the technical solutions in the embodiments of this disclosure are described in detail below.

FIG. 2 is a flowchart of a page processing method for a hosted program according to an embodiment of this disclosure. The hosted program runs within a host environment provided by a host program, and the page processing method is performed by the host program or an electronic device on which the host program runs. As shown in FIG. 2, the page processing method for a hosted program includes at least operation S210 to operation S230. A detailed description is as follows:

Operation S210: Acquire page navigation parameters of the hosted program, the page navigation parameters including address information of a first target page in the hosted program and custom routing information of the first target page.

In the embodiments of this disclosure, the hosted program is a program that relies on the host program and that can be used without the need of being downloaded and installed. For example, a mini program and a quick application are both hosted programs. In a computer environment, a software environment on which a hosted program relies is referred to as a host environment, and a program providing the host environment may be referred to as a host program. The host program may be, for example, an open platform, an application program capable of running a hosted program, or an operating system of a mobile terminal.

In some embodiments, the page navigation parameters may include a routing type (namely, routeType). The routing type is configured for instructing calling of the custom routing information of the first target page, and the custom routing information is configured for indicating a routing animation effect and animation presentation time. In an embodiment, the routing animation effect may be, for example, pulling up a page from the bottom, or gradually expanding a page from a position (such as, a side edge of a screen). The animation presentation time is configured for representing presentation time of the routing animation effect.

In some cases, a plurality of pages in the hosted program may be rendered by a plurality of rendering engines. Some rendering engines may support custom routing, and some rendering engines do not support custom routing. Therefore, in this embodiment, whether the first target page that currently needs to be rendered supports displaying the custom routing effect may be indicated more clearly by setting the routing type in the page navigation parameters, and a custom routing effect may be automatically rendered based on the custom routing information and the routing type. In addition, the routing animation effect and the animation presentation time are indicated by using the custom routing information, whereby the custom routing effect can be custom relatively simply. Therefore, efficiency of customization of the routing effect is improved, and the custom routing effect meets an actual requirement.

In some embodiments, a process in which the host program acquires the page navigation parameters of the hosted program may be as follows: the host program receives a calling request transmitted by a base library of the hosted program, and then acquires the page navigation parameters from the calling request. For example, if the hosted program is a mini program, the calling request transmitted by the base library may be navigateTo.

In addition, the base library may be configured to provide basic code related to a virtual DOM (VD) rendering mechanism, may further provide an encapsulated built-in component and an Application Programming Interface (API) of a logical layer, and may further provide basic code of another supplementary capability (such as a custom component and a plug-in), and the like. In general, the base library of the hosted program is mainly responsible for processing a series of framework logics such as data binding, a component system, an event system, and a communication system.

Operation S220: Determine a rendering engine identifier and a page identifier that correspond to the first target page.

In some embodiments, the rendering engine identifier is configured for identifying a rendering engine, and may uniquely indicate one rendering engine. In the embodiments of this disclosure, the rendering engine identifier corresponding to the first target page is identification information indicating a rendering engine configured to render the first target page. The page identifier is configured for identifying the page, and the page identifier corresponding to the first target page is configured for uniquely identifying the first target page.

Because one rendering engine in the embodiments of this disclosure may render a plurality of pages, one rendering engine identifier may correspond to one or more page identifiers. If one rendering engine identifier corresponds to one page identifier, it indicates that the rendering engine may render one page. If one rendering engine identifier corresponds to a plurality of page identifiers, it indicates that the rendering engine may render a plurality of pages. Therefore, if the first target page is rendered by the first rendering engine supporting custom routing, after the rendering engine that renders the first target page is determined, a corresponding rendering engine identifier may be acquired, namely, the rendering engine identifier corresponding to the first target page. Then, the page identifier corresponding to the first target page is acquired according to a page that needs to be rendered by the rendering engine corresponding to the rendering engine identifier. Custom routing refers to a rendering effect of rendering and displaying a page according to custom routing information.

Operation S230: Establish a page tree corresponding to the hosted program according to the page identifier corresponding to the first target page, and call a rendering engine corresponding to the rendering engine identifier, to render the first target page based on the page tree and the page navigation parameters.

In some embodiments, the page tree corresponding to the hosted program is configured for representing a navigation relationship among a plurality of pages in the hosted program, for example, representing navigation from a page A to a page B. After the rendering engine corresponding to the rendering engine identifier is called to render the first target page based on the page tree and the page navigation parameters, the first target page may be presented in the hosted program in a custom routing manner corresponding to the custom routing information in the page navigation parameters.

In some embodiments, a process in which the host program establishes the page tree corresponding to the hosted program according to the page identifier, and calls the rendering engine corresponding to the rendering engine identifier, to render the first target page based on the page tree and the page navigation parameters may be as follows: the host program returns the page navigation parameters, the rendering engine identifier, and the page identifier to the base library, to establish the page tree corresponding to the hosted program by using the base library, and calls the rendering engine corresponding to the rendering engine identifier, to render the first target page based on the page tree and the page navigation parameters.

In this way, because the base library can provide the basic code related to the VD rendering mechanism, the encapsulated built-in component, the API of the logical layer, and other supplementary capabilities (such as a custom component and a plug-in), the page tree is established based on the base library, and a rendering engine backend having a relatively strong rendering capability is called to perform rendering, which can improve rendering efficiency, to obtain a rendering effect of relatively high quality.

According to the technical solutions in the embodiment shown in FIG. 2, a developer is allowed to set the custom routing information of the specific page in the page navigation parameters of the hosted program, and then a custom routing manner of the page may be rendered by the rendering engine based on the custom routing information, whereby requirements of developers for high customization and deep optimization may be met, personalization, refinement, and flexibility of page routing are improved, and requirements of users for a natural and smooth experience in page switching are also met.

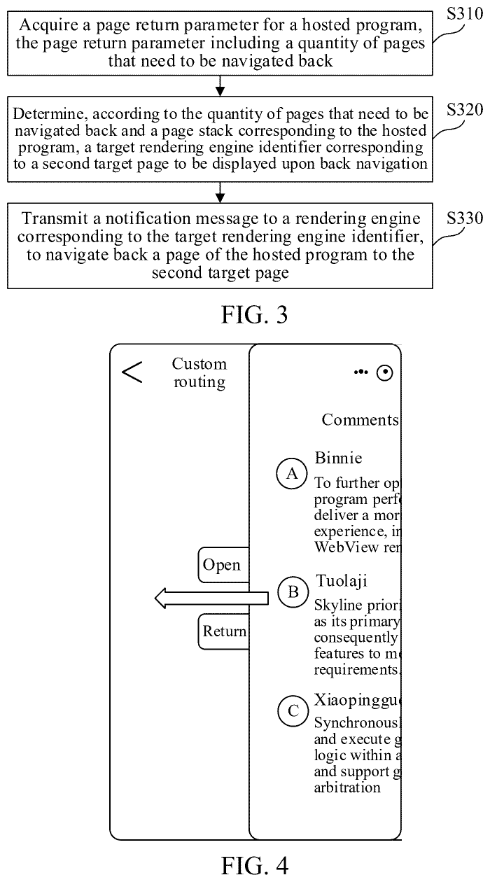

FIG. 3 is a flowchart of a page processing method for a hosted program according to an embodiment of this disclosure. The hosted program runs within a host environment provided by a host program, and the page processing method is performed by the host program or an electronic device on which the host program runs. As shown in FIG. 3, the page processing method for a hosted program includes at least operation S310 to operation S330. A detailed description is as follows:

Operation S310: Acquire a page return parameter for the hosted program, the page return parameter including a quantity of pages that need to be navigated back.

In actual application, the operation of acquiring the page return parameter for the hosted program is usually performed in response to a page return operation performed by a user. That is, after the page return operation triggered by the user is detected, the operation of acquiring the page return parameter for the hosted program is performed. The page return operation is an operation of triggering display of a previously displayed page, that is, an operation of navigating back to a history page. Correspondingly, the page return parameter is a parameter configured for indicating pages that need to be displayed upon back navigation, and may include the quantity of pages that need to be navigated back. The quantity of pages that need to be navigated back is a quantity of pages that need to be navigated back from a currently displayed page to a history page that needs to be displayed in response to the page return operation.

In some embodiments, in the page return parameter, the quantity of pages that need to be navigated back may be set, or may be triggered based on the page return operation. In an embodiment, the page return operation may be a trigger operation for a page return control on the hosted program, or may be a gesture operation of page return (such as an operation of sliding on a side of a screen). In a case of the page return operation, in the page return parameter, the number of pages that need to be navigated back may be a set value, for example, may be 1. That is, one page is navigated back.

Operation S320: Determine, according to the quantity of pages that need to be navigated back and a page stack corresponding to the hosted program, a target rendering engine identifier corresponding to a second target page to be displayed upon back navigation.

In some embodiments, the page stack corresponding to the hosted program is configured for storing pages of the hosted program. The pages may be stored based on a navigation sequence. The first element in the page stack is a home page of the hosted program, and the last element (namely, an element at the top of the stack) is a current page of the hosted program. Based on this, forward traversal may be performed from the current page according to the quantity of pages that need to be navigated back and the page stack corresponding to the hosted program, to determine the second target page that needs to be displayed upon back navigation. Then, a target rendering engine identifier corresponding to the second target page, namely, an identifier of a rendering engine configured to render the second target page, may be determined.

Operation S330: Transmit a notification message to a rendering engine corresponding to the target rendering engine identifier, to navigate back a page of the hosted program to the second target page.

In this way, in the foregoing manner, in response to the page return operation triggered by the user, the target rendering engine identifier corresponding to the second target page that needs to be displayed upon back navigation is correspondingly searched, and the second target page is rendered by the rendering engine corresponding to the target rendering engine identifier, whereby the second target page is displayed upon back navigation. This provides reliable technical support for back navigation and display of a page in a hosted program.

In some embodiments, if the rendering engine corresponding to the target rendering engine identifier is a first rendering engine supporting custom routing, and the first rendering engine is capable of rendering a plurality of pages (e.g., the first rendering engine is of a first rendering engine type that supports custom routing and is capable of rendering a plurality of pages), a quantity of pages that actually need to be navigated back within the first rendering engine corresponding to the target rendering engine identifier may be determined according to the quantity of pages that need to be navigated back and the page stack corresponding to the hosted program. Then, the quantity of pages that actually need to be navigated back is added to the notification message.

Because a plurality of pages may be rendered within the first rendering engine (such as a Flutter engine), when the second target page that needs to be displayed upon back navigation is rendered by the rendering engine, for the rendering engine, page back-navigation may be performed within the rendering engine. Therefore, the quantity of pages that actually needs to be navigated back within the rendering engine corresponding to the target rendering engine identifier needs to be determined. In this way, the quantity of pages that actually need to be navigated back is further determined based on the page stack and the rendering engine corresponding to the second target page, to ensure that page back-navigation is reliably performed, and avoid occurrence of a page back-navigation failure or error.

In an embodiment, if a current page of the hosted program and the second target page are both pages rendered by the rendering engine corresponding to the target rendering engine identifier, and the rendering engine corresponding to the target rendering engine identifier is the first rendering engine, it indicates that the second target page is another page rendered by the rendering engines corresponding to the target rendering engine identifier. That is, the rendering engine corresponding to the target rendering engine identifier renders a plurality of pages. Therefore, the notification message may be further configured for instructing the rendering engine (that is, the first rendering engine) corresponding to the target rendering engine identifier to perform routing animation rendering on the second target page. That is, one first rendering engine performs routing animation rendering during page back-navigation. Therefore, related processing resources and communication resources are saved, and efficiency of routing animation rendering during page back-navigation is improved.

In some embodiments, rendering engines configured to render pages of the hosted program may further include second rendering engines (such as Web View), and each second rendering engine is capable of rendering one page, that is, one second rendering engine can render only one page (e.g., the second rendering engines are of a second rendering engine type that is capable of rendering a single page). If the rendering engine corresponding to the target rendering engine identifier is the second rendering engine, routing animation rendering may be performed on the second target page by using the host program. That is, when the second target page is rendered by the second rendering engine that does not support custom routing, the host program may render a routing animation of the second target page according to a default routing animation rendering mechanism. The host program renders a routing effect of the second target page, whereby page back-navigation is reliably performed. In addition, because interaction with another rendering engine is not required, related resources may be saved, and efficiency of routing animation rendering during page back-navigation may be improved to an extent.

In some embodiments, when a redirection request for redirecting the current page in the hosted program to a specified page is received, a rendering engine corresponding to the current page may be acquired. If the rendering engine corresponding to the current page is the first rendering engine supporting custom routing (the first rendering engine is capable of rendering a plurality of pages), and a type of the specified page is a first rendering engine page (namely, a page rendered by the first rendering engine), the first rendering engine may be directly reused to render the specified page within the first rendering engine.

In addition, the redirection request is a request configured for redirecting the current page to the specified page, and may be generated in response to a page redirection operation triggered by the user. For example, the user may switch to display the specified page, such as a home page of the hosted program, a service page of the hosted program, or a personal information page of the hosted program, by triggering the page redirection operation. Correspondingly, the redirection request configured for indicating the specified page may be generated in response to the page redirection operation.

In this way, in response to the redirection request for redirecting from the current page to the specified page, in a case that the current page and the specified page both support rendering by the first rendering engine, the first rendering engine may be directly reused to render the specified page, whereby rendering efficiency of the specified page is improved, displaying a custom routing effect of the specified page is supported, and related resources are saved.

In some embodiments, rendering engines configured to render pages of the hosted program may further include second rendering engines, and each second rendering engine is capable of rendering one page, that is, one second rendering engine can render only one page. If the rendering engine corresponding to the current page is the first rendering engine, and a type of the specified page is a second rendering engine page (namely, a page rendered by the second rendering engine), the specified page rendered by the second rendering engine may be established at the top of the page stack of the hosted program, and the first rendering engine is instructed to navigate back one page.

In a case that a plurality of pages of the hosted program support rendering by a plurality of rendering engines, when the rendering engine configured to render the specified page for redirection is the second rendering engine, and the rendering engine configured to render the current page is the first rendering engine, the specified page rendered by the second rendering engine may be established at the top of the page stack, and the first rendering engine is instructed to navigate back one page. Therefore, correctness of the page stack is ensured, and page redirection is reliably performed.

In some embodiments, rendering engines configured to render pages of the hosted program may further include second rendering engines, and each second rendering engine is capable of rendering one page, that is, one second rendering engine can render only one page. If the rendering engine corresponding to the current page is the second rendering engine, and a type of the specified page is the first rendering engine page, the current page may be deleted from the top of the page stack of the hosted program, and the specified page is rendered by a newly created first rendering engine.

In a case that a plurality of pages of the hosted program support rendering by a plurality of rendering engines, when the rendering engine configured to render the specified page for redirection is the first rendering engine, and the rendering engine configured to render the current page is the second rendering engine, the current page may be deleted from the top of the page stack, and the specified page is rendered by the first rendering engine. Therefore, correctness of the page stack is ensured, and page redirection is reliably performed.

In some embodiments, if the first rendering engine supporting custom routing can render a plurality of pages, pages, rendered by the first rendering engine, of the hosted program respectively correspond to different data isolation zones (such as Dart Isolate), routing contexts corresponding to the pages are associated with the data isolation zones corresponding to the pages, and each routing context includes a page node tree (such as Shadow Tree). In this case, an operation performed on the page node tree acts on the data isolation zone associated with the routing context, whereby data isolation between the plurality of pages within the first rendering engine is ensured.

By using the foregoing mechanism, the routing contexts corresponding to the pages rendered by the first rendering engine are isolated and stored. Data isolation between the pages rendered by the first rendering engine may be ensured, and furthermore, sharing of some resources of the pages rendered by the first rendering engine may be achieved, to save related storage resources.

The following uses an example in which the hosted program is a mini program, the host program is an application program client, the first rendering engine is a Flutter engine, and the second rendering engine is Web View, to elaborate the implementation details of the technical solutions in the embodiments of this disclosure.

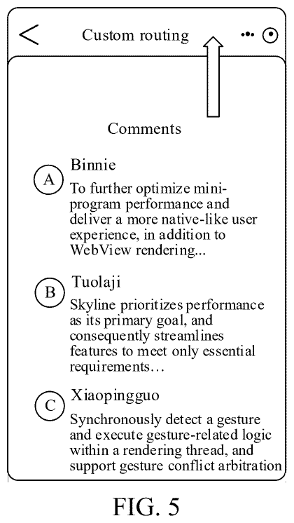

As shown in FIG. 4, currently, a page of the mini program is rendered by Web View. When page navigation is performed, a page can only be pushed from a right end to a left end of a screen. Such a page routing manner results in a single page presentation effect. It is not only difficult to meet requirements of developers for high customization and deep optimization, but also difficult to meet requirements of users for a natural and smooth experience in page switching. However, in the embodiments of this disclosure, custom routing may provide developers with greater freedom and creativity. Developers may design their own routing animation solutions based on their own service requirements, to create a more personalized and refined mini-program interaction experience. In addition, such a custom routing manner also makes switching between pages of the mini program more natural and smoother, giving users a smoother operating experience. For example, as shown in FIG. 5, the page may be pushed upward from the bottom of the screen.

In some embodiments, custom routing in this disclosure may be implemented by Skyline and Flutter. To use custom routes in consecutive Skyline pages, a renderer field may be configured as Skyline in a page configuration json file.

When custom routing is used, a custom route may be first declared. For example, one custom route may be declared through a wx.router.addRouteBuilder (adding a route builder) interface. In an example, the custom route may be declared as follows:

```
wx.router.addRouteBuilder(
  “HalfScreenDialog”,
  customRouteBuilder
)
```

In the foregoing declaration, a first parameter “HalfScreenDialog” is a name of the custom route, and a second parameter customRouteBuilder is a building function of the custom route. The building function is a core for a developer to perform custom routing, and an animation effect, animation time, and the like may be defined in the building function.

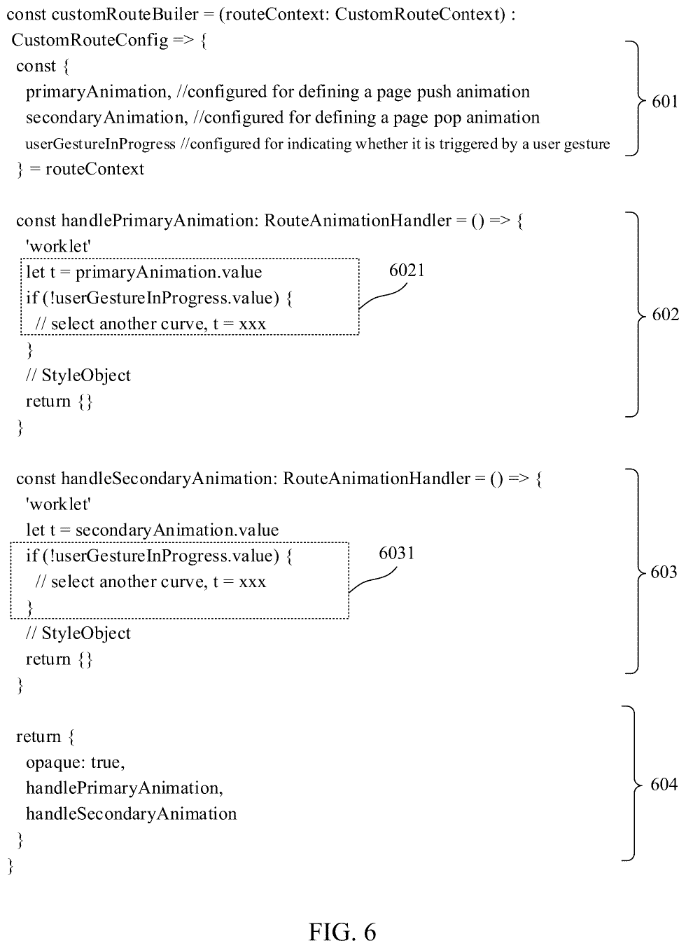

An example builder function may be shown in FIG. 6. User routing configuration information in one builder function is specifically defined. Routing context information (namely, routeContext) is indicated by a code segment 601. Because an old page will exit when a new page is opened, a parameter representing a new page push animation may be represented by primary Animation, a parameter representing an old page pop animation may be represented by secondaryAnimation, and whether a user gesture is supported to trigger page navigation is indicated by userGestureInProgress.

In FIG. 6, a code segment 602 is configured for defining the new page push animation. The code segment 6021 is configured for representing a set value of a worklet animation, which is a default value of primary Animation (namely, primary Animation.value). If page navigation is not triggered by a user gesture, another value is selected, and finally, an animation style is returned. In FIG. 6, a code segment 603 is configured for defining the old page pop animation. The code segment 6031 is configured for representing a set value of a worklet animation, which is a default value of secondary Animation (namely, secondary Animation.value). If page navigation is not triggered by a user gesture, another value is selected, and finally, an animation style is returned. In FIG. 6, a code segment 604 is configured for returning the defined new page push animation and old page pop animation.

After the custom route is declared, the declared custom route may be taken as the page navigation parameter, and custom page routing is achieved in a game. In some aspects, when wx.navigateTo (namely, a page navigation function) is called to perform page navigation, a second parameter routeType (a routing type) may be added, and is set to the name “HalfScreenDialog” of the declared custom route. In this way, page navigation is performed according to a routing animation set in the builder function. In an example, the wx.navigateTo function is defined as follows (url is an address of a page that needs to be navigated to):

```
wx.navigateTo({
  url: ‘pageB’,
  routeType: ‘HalfScreenDialog’
})
```

In an embodiment of this disclosure, when page return is performed, custom routing supports a gesture to achieve a gesture return animation effect. In some aspects, a gesture component may be nested in an outermost layer of a page, and during gesture callback, a variable of the custom route is changed, to change a page presentation state. In the page, this.customRouteContext (user routing context) includes all variables when the route builder is defined on the current page, namely, routeContext in the declared builder function.

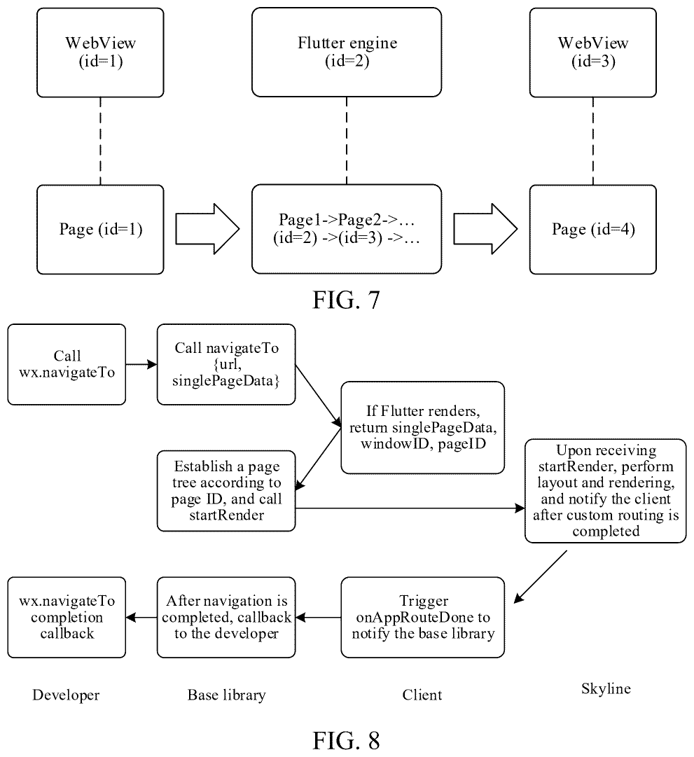

In an embodiment of this disclosure, when Skyline is taken as a rendering backend, page navigation has abundant animation support. Therefore, when a page is rendered by an independent Flutter engine, a routing animation is controlled by the application program client, and a routing animation capability of Skyline is not used. However, when consecutive pages are rendered by a same Flutter engine, custom routing may be implemented by the routing animation capability of Skyline. To render a plurality of pages within a same Flutter engine, id of the Flutter engine may be referred to as windowID, and id of a page may be referred to as pageID. Each windowID may correspond to one or more pageIDs, but each pageID belongs to only one windowID. In addition, in the embodiments of this disclosure, it may be supported that Web View and Skyline exist in a same mini program, that is, a hybrid routing manner of Web View and Skyline is supported. In some aspects, as shown in FIG. 7, a Web View engine whose id=1 corresponds to a page whose id=1; a Flutter engine whose id=2 corresponds to a page whose id=2 and a page whose id=3; and a Web View engine whose id=3 corresponds to a page whose id=4.

In an embodiment of this disclosure, it is assumed that an opening sequence of pages of the mini program is w-a->f-b->f-c->w-d->f-e, where “w-” represents a Web View rendered page, and “f-” represents a Flutter engine rendered page. In this example, two Flutter engines are generated, and Flutter engine1 supports rendering f-b and f-c; and Flutter engine2 supports rendering f-e. The application program client is responsible for a routing animation between Web View and the Flutter engine, and routing of pages (such as, f-b->f-c) in the Flutter engine is controlled by Skyline. This part may have a custom routing animation. Because the same Flutter engine may be reused for consecutive Flutter engine rendered pages, system memory consumption may be reduced. In addition, the application program client has a complete page stack, and a base library keeps consistency with the client page stack according to onAppRoute (an API triggered during page switching) and onAppRouteDone events. When the routing animation is generated by the application program client, trigger timing of the two events is completely determined by the application program client. When custom routing is performed in the Flutter engine, the onAppRouteDone event is notified by Skyline to the application program client. The following describes a page change scenario in the embodiments of this disclosure:

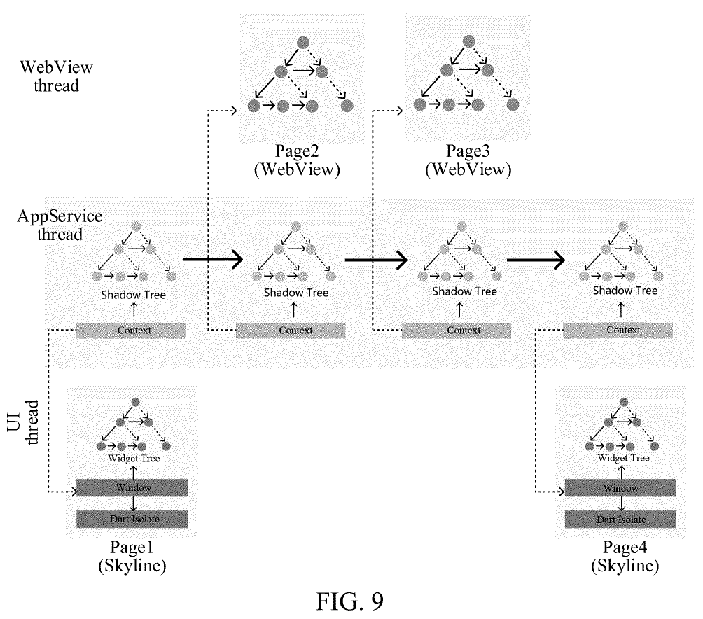

In an embodiment of this disclosure, when page navigation needs to be performed, as shown in FIG. 8, a navigation logic of a custom route includes: when a developer calls wx.navigateTo to perform page navigation, a base library calls navigateTo, which carries parameters {url, singlePageData}. singlePageData is a name of the defined custom route, and is “HalfScreenDialog” in the foregoing embodiments. Then, the application client triggers an onAppRoute event. If a new page that needs to be navigated to is rendered by Flutter, a parameter returned to the base library carries incoming singlePageData, and windowID and pageID are populated into the parameter. Further, the base library creates a new page tree based on new pageID. After the new page tree is created, startRender is called to perform page rendering. After receiving startRender, the rendering backend Skyline performs page layout and drawing, and renders a custom routing effect according to the defined custom routing parameter. After routing is completed by the rendering backend, the client is notified. The client triggers onAppRouteDone to the base library, and the base library calls back to the developer, to complete callback.

In addition, when the Web View engine is switched to the Flutter engine, the page routing animation is completed by the application program client, while page navigation within the Flutter engine, namely, navigation to a Flutter engine rendered page, the page routing animation is completed by Skyline.

In an embodiment of this disclosure, when page return needs to be performed, the base library calls a navigateBack function (a function configured for page back-navigation), which carries a parameter delta (namely, a quantity of pages to be navigated back). The application program client calculates, according to the delta and the page stack, which rendering engine renders a target page that needs to be displayed upon back navigation. If the target page falls within a Flutter engine, because the Flutter engine may render a plurality of pages, the Flutter engine needs to be notified of a quantity of pages that actually needs to be navigated back (namely, calculatedDelta) within the Flutter engine, and whether a page animation needs to be created. If the page animation needs to be created, the rendering backend notifies the application program client after popping a page, and the application program client triggers onAppRouteDone to the base library.

It is assumed that an opening sequence of pages of the mini program is w-a->f-b->f-c->w-d->f-e, where “w-” represents a Web View rendered page, and “f-” represents a Flutter engine rendered page, two Flutter engines are generated, Flutter engine1 is configured to render f-b and f-c; and Flutter engine2 is configured to render f-e.

If the current page is f-e, navigateBack in the base library is called with delta: 2, in this case, it is determined that a return to the page f-c, and an animation is handed over to the client without notifying Skyline. This is because page back-navigation from the page f-e to the page f-c is not page back-navigation within a same Flutter engine.

If the current page is f-e, navigateBack in the base library is called with delta: 3, and in this case, it is determined that a return to the page f-b is needed. Because page back-navigation from the page f-e to the page f-b is not page back-navigation within the Flutter engine, an animation may be handed over to the application program client, and Skyline is notified of the quantity of pages that actually need to be navigated back (calculatedDelta: 1) within Flutter engine1, and does not need to create an animation.

If the current page is f-c, navigateBack in the base library is called with delta: 1, and in this case, it is determined that a return to the page f-b is needed. Because page back-navigation from the page f-c to the page f-b is page back-navigation within the Flutter engine, Skyline may be notified of the quantity of pages that actually need to be navigated back (calculatedDelta: 1) within the Flutter engine1, and needs to create an animation. That is, Skyline needs to create an animation only when the current page and the target page are within a same Flutter engine.

In an embodiment of this disclosure, a gesture operation may also cause page return. For example, a return key is tapped by using a gesture, or page return is triggered by using a gesture slide, and this case is equivalent to delta: 1, and processing may be performed according to the foregoing page return operation. In addition, for a first page in the Flutter engine, when return is triggered by a gesture, because page return from the first page to a page (such as a Web View page) in another rendering engine is required, the page routing animation may be processed by the application program client. However, from a second page of the Flutter engine, if return is triggered by a gesture, because a page return operation is performed in the same Flutter engine, the page routing animation may be processed by Skyline. In addition, when page return is triggered by a gesture operation within the Flutter engine, Skyline notifies the client of return start and end timing. That is, Skyline notifies the application program client of an onAppRouteDone event.

In an embodiment of this disclosure, when page redirection is required, if the current page is w-d and redirection to f-e is required, the application program client may delete current Web View at the top of the stack, create a new Flutter engine, and instruct Skyline to call navigateTo to redirect to the page f-e. If the current page is f-c and redirection to f-e is required, because the pages are rendered by a same Flutter engine, a previous Flutter engine may be reused, and the application program client instructs Skyline to call redirectTo to redirect to the page f-e. If the current page is f-c and redirection to w-d is required, the application client may create new Web View at the top of the stack, and instruct Skyline to call navigateBack (that is, return to) to navigate back one page, but Skyline does not need to create an animation, to maintain correctness of the page stack of the Flutter engine.

In an embodiment of this disclosure, because a hybrid routing manner of Web View and Skyline is supported in a same mini program, a solution of mixed use of Web View and Flutter rendering framework in one mini program may be implemented based on a multi-Flutter View (that is, Flutter page) mechanism. In some aspects, the developer may configure, in advance in a page.json file of a page, a renderer that needs to be used for the page. Correspondingly, during route navigation, the client may determine to push Web View or Flutter View according to the configuration in the page.json file. The multi-Flutter View mechanism is very similar to a multi-Web View mechanism, and a difference lies in that a plurality of Flutter Views share resources (such as texture resources and some internal objects) at a bottom layer, to save memory. To support the plurality of Flutter Views, as shown in FIG. 9, an isolation mechanism may be designed within Skyline. For a Skyline page, Context and Window in Skyline are bound to Dart Isolate (an isolation zone) of the page (each Skyline page has one Dart Isolate). One Context holds one Shadow Tree, and all operations performed on Shadow Tree act on Dart Isolate corresponding to Shadow Tree, whereby state isolation from Shadow Tree to Dart Isolate is implemented.

Through the technical solutions in the embodiments of this disclosure, custom page routing of a mini program may be implemented, and brings good user experience to the mini program. Compared with Web View, the technical solutions in the embodiments of this disclosure can achieve a routing animation effect that is closer to native implementations, such as sinking routing and card transitions. These effects can allow users to experience smoother page switching. In addition, through custom routing, the mini program can obtain more possibilities and flexibility, to further improve user experience and application value.

Embodiments of an apparatus embodiments of this disclosure are described below, and the apparatus may be configured to perform the page processing method for a hosted program provided in the foregoing embodiments of this disclosure. For details not disclosed in the embodiments of the apparatus of this disclosure, refer to the foregoing embodiments of the page processing method for a hosted program of this disclosure.

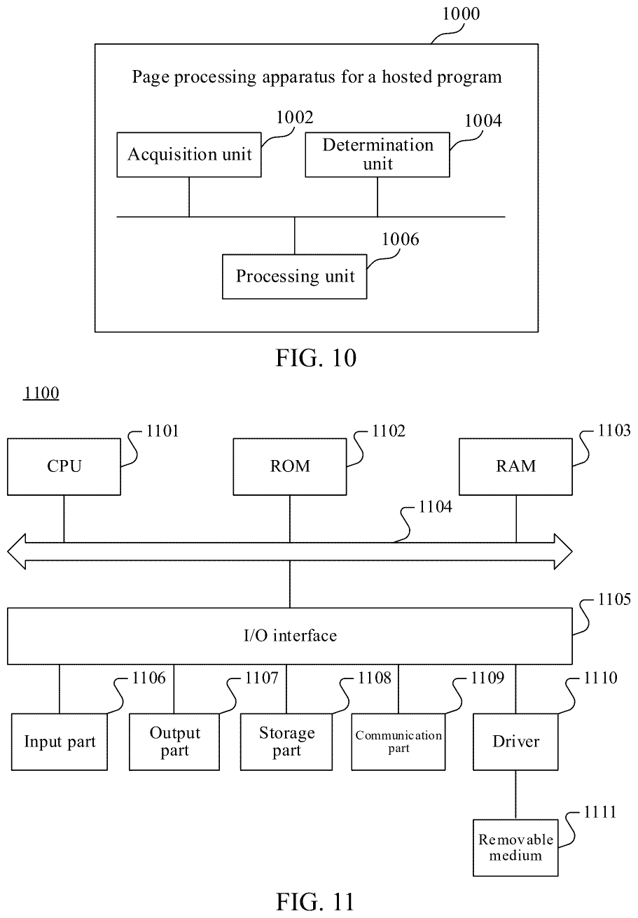

FIG. 10 is a block diagram of a page processing apparatus for a hosted program according to an embodiment of this disclosure. The hosted program runs within a host environment provided by a host program, and the page processing apparatus is applied to the host program.

As shown in FIG. 10, a page processing apparatus 1000 for a hosted program according to an embodiment of this disclosure includes: an acquisition unit 1002, a determination unit 1004, and a processing unit 1006.

The acquisition unit 1002 is configured to acquire page navigation parameters of the hosted program, the page navigation parameters including address information of a first target page in the hosted program and custom routing information of the first target page. The determination unit 1004 is configured to determine a rendering engine identifier and a page identifier that correspond to the first target page. The processing unit 1006 is configured to establish a page tree corresponding to the hosted program according to the page identifier, and call a rendering engine corresponding to the rendering engine identifier, to render the first target page based on the page tree and the page navigation parameters.

In some embodiments of this disclosure, based on the foregoing solutions, the acquisition unit 1002 is further configured to: acquire a page return parameter for the hosted program, the page return parameter including a quantity of pages that need to be navigated back; the determination unit 1004 is further configured to: determine, according to the quantity of pages that need to be navigated back and a page stack corresponding to the hosted program, a target rendering engine identifier corresponding to a second target page to be displayed upon back navigation; and the page processing apparatus for a hosted program further includes: a transmission unit, configured to transmit a notification message to a rendering engine corresponding to the target rendering engine identifier, to navigate back a page of the hosted program to the second target page.

In some embodiments of this disclosure, based on the foregoing solutions, the determination unit 1004 is further configured to: determine, according to the quantity of pages that need to be navigated back and the page stack corresponding to the hosted program, a quantity of pages that actually need to be navigated back within a first rendering engine if the rendering engine corresponding to the target rendering engine identifier is the first rendering engine supporting custom routing, the first rendering engine being capable of rendering a plurality of pages; and the transmission unit is further configured to: add the quantity of pages that actually need to be navigated back to the notification message.

In some embodiments of this disclosure, based on the foregoing solutions, if a current page of the hosted program and the second target page are both pages rendered by the rendering engine corresponding to the target rendering engine identifier, and the rendering engine corresponding to the target rendering engine identifier is the first rendering engine, the notification message is further configured for instructing the first rendering engine to perform routing animation rendering on the second target page.

In some embodiments of this disclosure, based on the foregoing solutions, rendering engines configured to render pages of the hosted program further include second rendering engines, and each second rendering engine is capable of rendering one page; and the processing unit 1006 is further configured to: perform routing animation rendering on the second target page by using the host program if the rendering engine corresponding to the target rendering engine identifier is the second rendering engine.

In some embodiments of this disclosure, based on the foregoing solutions, the acquisition unit 1002 is configured to: acquire, in response to a page return operation triggered for the hosted program, the page return parameter including the quantity of pages that need to be navigated back as a set value.

In some embodiments of this disclosure, based on the foregoing solutions, the acquisition unit 1002 is further configured to: acquire a rendering engine corresponding to the current page when a redirection request for redirecting the current page in the hosted program to a specified page is received; and the processing unit 1006 is further configured to: render the specified page within the first rendering engine if the rendering engine corresponding to the current page is the first rendering engine supporting custom routing, and a type of the specified page is a first rendering engine page.

In some embodiments of this disclosure, based on the foregoing solutions, the rendering engines configured to render the pages of the hosted program further include the second rendering engines, and each second rendering engine is capable of rendering one page; and the processing unit 1006 is further configured to: establish the specified page rendered by the second rendering engine at the top of the page stack of the hosted program if the rendering engine corresponding to the current page is the first rendering engine, and the type of the specified page is a second rendering engine page, and instruct the first rendering engine to navigate back one page.

In some embodiments of this disclosure, based on the foregoing solutions, the rendering engines configured to render the pages of the hosted program further include the second rendering engines, and each second rendering engine is capable of rendering one page; and the processing unit 1006 is further configured to: delete the current page from the top of the page stack of the hosted program if the rendering engine corresponding to the current page is the second rendering engine, and the type of the specified page is the first rendering engine page, and render the specified page by a newly created first rendering engine.

In some embodiments of this disclosure, based on the foregoing solutions, when acquiring the page navigation parameters of the hosted program, the processing unit 1006 is configured to: receive a calling request transmitted by a base library of the hosted program, and acquire the page navigation parameters from the calling request; and when establishing the page tree corresponding to the hosted program according to the page identifier, and calling the rendering engine corresponding to the rendering engine identifier, to render the first target page based on the page tree and the page navigation parameters, the processing unit 1006 is configured to: return the page navigation parameters, the rendering engine identifier, and the page identifier to the base library, to establish the page tree corresponding to the hosted program by using the base library, and call the rendering engine corresponding to the rendering engine identifier, to render the first target page based on the page tree and the page navigation parameters.

In some embodiments of this disclosure, based on the foregoing solutions, pages, rendered by the first rendering engine supporting custom routing, of the hosted program respectively correspond to different data isolation zones, routing contexts corresponding to the pages are associated with the data isolation zones corresponding to the pages, and each routing context includes a page node tree; and an operation performed on the page node tree acts on the data isolation zone associated with the routing context.

In some embodiments of this disclosure, based on the foregoing solutions, the page navigation parameters include a routing type. The routing type is configured for instructing calling of the custom routing information of the first target page, and the custom routing information is configured for indicating a routing animation effect and animation presentation time.

FIG. 11 is a schematic structural diagram of a computer system adapted to implement an electronic device according to an embodiment of this disclosure. The electronic device may be the foregoing electronic device on which the host program runs.

In addition, a computer system 1100 of the electronic device shown in FIG. 11 is merely an example, and does not constitute any limitation on functions and use ranges of the embodiments of this disclosure.

As shown in FIG. 11, the computer system 1100 may include a central processing unit (CPU) 1101, which may perform various suitable actions and processing based on a program stored in a read-only memory (ROM) 1102 or a program loaded from a storage part 1108 into a random-access memory (RAM) 1103, for example, perform the method according to the foregoing embodiments. The RAM 1103 further has various programs and data required for system operations stored therein. The CPU 1101, the ROM 1102, and the RAM 1103 are connected to each other through a bus 1104. An input/output (I/O) interface 1105 is also connected to the bus 1104.

The following components are connected to the I/O interface 1105: an input part 1106 including a keyboard, a mouse, and the like; an output part 1107 including a cathode ray tube (CRT), a liquid crystal display (LCD), a speaker, and the like; the storage part 1108 including a hard disk and the like; and a communication part 1109 including a network interface card such as a local area network (LAN) card and a modem. The communication part 1109 performs communication processing over a network such as the Internet. A driver 1110 is also connected to the I/O interface 1105 as required. A removable medium 1111, such as a magnetic disk, an optical disc, a magneto-optical disk, or a semiconductor memory, is installed on the drive 1110 as required, whereby a computer program read from the removable medium is installed into the storage part 1108 as required.

Particularly, according to the embodiments of this disclosure, the processes described above with reference to the flowcharts may be implemented as computer software programs. For example, the embodiments of this disclosure provide a computer program product, which includes a computer program carried on a computer-readable medium. The computer program is configured for performing the method shown in the flowchart. In such embodiments, the computer program may be downloaded from a network through the communication part 1109 and installed, and/or installed from the removable medium 1111. The CPU 1101 executes the computer program, to perform the various functions defined in the system of this disclosure.

In addition, the computer-readable medium shown in the embodiments of this disclosure may be a computer-readable signal medium or a computer-readable storage medium or any combination of the two. The computer-readable storage medium may be, for example, but is not limited to, an electric, magnetic, optical, electromagnetic, infrared, or semi-conductive system, apparatus, or component, or any combination of the above. More specific examples of the computer-readable storage medium may include, but are not limited to, an electrical connection with one or more conductors, a portable computer disk, a hard disk, an RAM, an ROM, an erasable programmable read-only memory (EPROM), a flash memory, an optical fiber, a portable compact disc read-only memory (CD-ROM), an optical storage device, a magnetic storage device, or any appropriate combination thereof. In this disclosure, the computer-readable storage medium may be any tangible medium including or storing a computer program, and the program may be used by or used in combination with an instruction execution system, apparatus, or device. In this disclosure, a computer-readable signal medium may include a data signal transmitted in a baseband or as part of a carrier, and carries a computer-readable computer program. A data signal propagated in such a way may assume a plurality of forms, including but not limited to, an electromagnetic signal, an optical signal, or any appropriate combination thereof. The computer-readable signal medium may further be any computer-readable medium other than a computer-readable storage medium. The computer-readable medium may transmit, propagate, or transfer a program that is used by or used in combination with an instruction execution system, apparatus, or device. The computer program included in the computer-readable medium may be transmitted through any suitable medium, including but not limited to, a wireless medium, a wired medium, or any suitable combination thereof.

The flowcharts and block diagrams in the accompanying drawings illustrate system architectures, functions, and operations that may be implemented by the system, the method, and the computer program product according to the embodiments of this disclosure. Each box in a flowchart or a block diagram may represent a module, a program segment, or a part of code. The module, the program segment, or the part of code includes one or more executable instructions configured for implementing specified logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by a dedicated hardware-based system configured to perform a specified function or operation, or may be implemented by a combination of dedicated hardware and a computer program.

A related unit described in the embodiments of this disclosure may be implemented in a software manner, or may be implemented in a hardware manner, and the unit described may alternatively be set in a processor. Names of the units do not constitute a limitation on the units in a specific case.

In another aspect, this disclosure further provides a computer-readable medium. The computer-readable medium may be included in the electronic device described in the foregoing embodiments, or may exist alone without being assembled into the electronic device. The foregoing computer-readable medium carries one or more computer programs. One electronic device executes the one or more computer programs, to cause the electronic device to implement the method according to the foregoing embodiments.

Although several modules or units of a device configured to perform actions are discussed in the foregoing detailed description, such division is not mandatory. Actually, according to the implementations of this disclosure, the features and functions of two or more modules or units described above may be embodied in one module or unit. On the contrary, the feature and function of one module or unit described above may be further divided to be embodied by a plurality of modules or units.

According to the descriptions of the foregoing implementations, it is noted that the example implementations described herein may be implemented by using software, or may be implemented by using software in combination with necessary hardware. Therefore, the technical solutions in the embodiments of this disclosure may be implemented in the form of a software product. The software product may be stored in a non-volatile storage medium (which may be a CD-ROM, a Universal Serial Bus (USB) flash drive, a removable hard disk, or the like) or on a network, and includes several instructions configured for causing an electronic device to perform the method according to the embodiments of this disclosure.

For example, the electronic device may be an electronic device on which a host program runs, and then the electronic device may perform the page processing method for a hosted program shown in FIG. 2 or FIG. 4.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A page processing method, comprising:
acquiring, by an electronic device that executes a host program that provides a host environment for a hosted program, page navigation parameters of the hosted program, the page navigation parameters comprising address information of a first target page in the hosted program and custom routing information of the first target page;
determining a rendering engine identifier for a rendering engine and a page identifier of the first target page;
establishing a page tree in the hosted program according to the page identifier; and
calling the rendering engine, to render the first target page based on the page tree and the page navigation parameters.

2. The page processing method according to claim 1, further comprising:
acquiring a page return parameter of the hosted program, the page return parameter comprising a quantity of pages for a back navigation;
determining, according to the quantity of pages and a page stack of the hosted program, a target rendering engine identifier for rendering a second target page that is to be displayed upon the back navigation; and
transmitting a notification message to a target rendering engine according to the target rendering engine identifier, to cause the hosted program to navigate back to the second target page.

3. The page processing method according to claim 2, wherein:
when the target rendering engine is of a first rendering engine type that supports custom routing and is capable of rendering a plurality of pages, the page processing method comprises:
determining, according to the quantity of pages and the page stack of the hosted program, an internal quantity of pages to navigate back within the target rendering engine; and
adding, to the notification message, the internal quantity of pages for navigating back within the target rendering engine.

4. The page processing method according to claim 3, wherein the transmitting the notification message comprises:
when a current page of the hosted program and the second target page are both rendered by the target rendering engine, transmitting the notification message that instructs the target rendering engine to perform routing animation rendering on the second target page.

5. The page processing method according to claim 2, wherein the pages of the hosted program are rendered by a plurality of rendering engines that are of a first rendering engine type or a second rendering engine type, each rendering engine of the second rendering engine type is capable of rendering of a single page; and the page processing method further comprises:
when the target rendering engine is of the second rendering engine type, using the host program to perform routing animation rendering for the second target page.

6. The page processing method according to claim 2, wherein the acquiring the page return parameter comprises:
acquiring, in response to a page return operation triggered in the hosted program, the page return parameter that includes the quantity of pages to navigate back.

7. The page processing method according to claim 1, further comprising:
receiving a redirection request for redirecting from a current page to a specified page in the hosted program;
acquiring a first rendering engine of the current page;
determining that the specified page is of a type to be rendered by a first rendering engine type that supports custom routing; and
rendering the specified page within the first rendering engine when the first rendering engine is of the first rendering engine type.

8. The page processing method according to claim 7, wherein pages of the hosted program are rendered by a plurality of rendering engines that are of the first rendering engine type or a second rendering engine type, each rendering engine of the second rendering engine type is capable of rendering of a single page; and the page processing method further comprises:
when the first rendering engine is of the first rendering engine type and the specified page is of a type to be rendered by a rendering engine of the second rendering engine type,
establishing the specified page that is rendered by a second rendering engine of the second rendering engine type at a top of a page stack of the hosted program, and
instructing the first rendering engine to navigate back one page.

9. The page processing method according to claim 7, wherein pages of the hosted program are rendered by a plurality of rendering engines that are of the first rendering engine type or a second rendering engine type, each rendering engine of the second rendering engine type is capable of rendering of a single page; and the page processing method further comprises:
when the first rendering engine of the current page is of a second rendering engine type and specified page is of a type to be rendered by a rendering engine of the first rendering engine type,
deleting the current page from a top of a page stack of the hosted program; and
rendering the specified page by a newly created rendering engine of the first rendering engine type.

10. The page processing method according to claim 1, wherein:
the acquiring the page navigation parameters comprises:
receiving a calling request transmitted by a base library of the hosted program; and
acquiring the page navigation parameters from the calling request; and
the establishing the page tree comprises:
returning the page navigation parameters, the rendering engine identifier, and the page identifier to the base library for the base library to establish the page tree of the hosted program.

11. The page processing method according to claim 1, wherein when a plurality of pages of the hosted program are rendered by a first rendering engine that supports custom routing, the plurality of pages respectively correspond to different data isolation zones for page data isolation, routing contexts of the plurality of pages are respectively associated with the different data isolation zones, and routing contexts comprise respective page node trees; and an operation performed on a page node tree in a routing context acts on a data isolation zone associated with the routing context.

12. The page processing method according to claim 1, wherein the page navigation parameters comprise a routing type, the routing type indicates a calling of the custom routing information of the first target page, and the custom routing information indicates a routing animation effect and an animation presentation time.

13. An apparatus for page processing, comprising processing circuitry configured to:
execute a host program that provides a host environment for a hosted program;
acquire page navigation parameters of the hosted program, the page navigation parameters comprising address information of a first target page in the hosted program and custom routing information of the first target page;
determine a rendering engine identifier for a rendering engine and a page identifier of the first target page;
establish a page tree in the hosted program according to the page identifier; and
call the rendering engine, to render the first target page based on the page tree and the page navigation parameters.

14. The apparatus according to claim 13, wherein the processing circuitry is configured to:
acquire a page return parameter of the hosted program, the page return parameter comprising a quantity of pages for a back navigation;
determine, according to the quantity of pages and a page stack of the hosted program, a target rendering engine identifier for rendering a second target page that is to be displayed upon the back navigation; and
transmit a notification message to a target rendering engine according to the target rendering engine identifier, to cause the hosted program to navigate back to the second target page.

15. The apparatus according to claim 14, wherein:
when the target rendering engine is of a first rendering engine type that supports custom routing and is capable of rendering a plurality of pages, the processing circuitry is configured to:
determine, according to the quantity of pages and the page stack of the hosted program, an internal quantity of pages to navigate back within the target rendering engine; and
add, to the notification message, the internal quantity of pages for navigating back within the target rendering engine.

16. The apparatus according to claim 15, wherein:
when a current page of the hosted program and the second target page are both rendered by the target rendering engine, the processing circuitry is configured to:
transmitting the notification message that instructs the target rendering engine to perform routing animation rendering on the second target page.

17. The apparatus according to claim 14, wherein:
the pages of the hosted program are rendered by a plurality of rendering engines that are of a first rendering engine type or a second rendering engine type, each rendering engine of the second rendering engine type is capable of rendering of a single page; and
when the target rendering engine is of the second rendering engine type, the processing circuitry is configured to:
use the host program to perform routing animation rendering for the second target page.

18. The apparatus according to claim 14, wherein the processing circuitry is configured to:
acquire, in response to a page return operation triggered in the hosted program, the page return parameter that includes the quantity of pages to navigate back.

19. The apparatus according to claim 13, wherein the processing circuitry is configured to:
receive a redirection request for redirecting from a current page to a specified page in the hosted program;
acquire a first rendering engine of the current page;
determine that the specified page is of a type to be rendered by a first rendering engine type that supports custom routing; and
render the specified page within the first rendering engine when the first rendering engine is of the first rendering engine type.

20. A non-transitory computer-readable storage medium storing instructions which when executed by at least one processor cause the at least one processor to perform:
executing a host program that provides a host environment for a hosted program;
acquiring page navigation parameters of the hosted program, the page navigation parameters comprising address information of a first target page in the hosted program and custom routing information of the first target page;
determining a rendering engine identifier for a rendering engine and a page identifier of the first target page;
establishing a page tree in the hosted program according to the page identifier; and
calling the rendering engine, to render the first target page based on the page tree and the page navigation parameters.
